(19) United States
(12) Patent Application Publication
(10) Pub. No.: US 2004/0101815 A1
(43) Pub. Date: May 27, 2004

(54) Biofidelic seating apparatus with binaural acoustical sensing

(76) Inventors: Mark A. Jay, Ann Arbor, MI (US); Terry O'Bannon, Royal Oak, MI (US)

Correspondence Address: Jeffrey J. Chapp, Artz & Artz, P.C., 28333 Telegraph Road, Suite 250, Southfield, MI, 48034, US

(21) Appl. No.: 10/306,343

(22) Filed: Nov. 27, 2002

(51) Int. Cl. G09B 23/28

(52) U.S. Cl. 434/274

(57) ABSTRACT

An anthropomorphic testing device (10) includes a biofidelic head (14) having substantially correct density, mass, and center of gravity. A biofidelic body (16) is coupled to the biofidelic head (14) and has a skeletal frame structure (18) having substantially correct density, mass, geometry, and compliance. A biofidelic skin (20) covers at least a portion of the skeletal frame structure (18) and has substantially anatomically correct surface geometry, density, and compliance. The biofidelic head (14) may include a binaural sensing system (12).

### RELATED APPLICATION

The present invention is related to U.S. Pat. No. 6,206,703 B1 entitled “Biofidelic Human Seating Surrogate Apparatus”, which is incorporated by reference herein.

### TECHNICAL FIELD

The present invention relates generally to biofidelic seating apparatuses, and more particularly, to a method and apparatus for in-situ acoustical and vibrational measurements including measurements corresponding to occupant head positions within a vehicle.

### BACKGROUND OF THE INVENTION

Vehicle manufactures continuously design vehicles so as to minimize buzz, squeak, and rattle associated with various vehicle components and the amount of acoustical noise that may be generated therefrom and heard by a vehicle occupant. Ride comfort of an occupant is affected by buzz, squeak, and rattle of a seating system and vibrational and acoustical noise generated therefrom. It is desirable for vehicle occupants to experience low noise levels while in the vehicle, especially within a frequency range of approximately 1 KHz and 5 KHz, for which occupants are generally most sensitive.

Vibrational noise refers to lower frequencies and acoustical noise refers to higher frequencies that can be heard by a vehicle occupant. When a seating system is generating a large amount of vibrational and acoustical noise dynamic ride comfort may be perceived by a vehicle occupant to be unpleasant or distracting and is therefore undesirable. Additional vibrational or acoustical noise may also be generated when using a binaural testing device in combination with the seating system, which may generate false noise data that would not normally be heard by a vehicle occupant.

Various occupant characteristics affect vehicle seat buzz, squeak, and rattle or mechanical, vibrational, and acoustical seat performance. The occupant characteristics include occupant height, weight, sex or gender, make-up, muscularity, percent body fat, etc. The occupant characteristics in combination for a particular occupant provide a set of boundary conditions, which can be somewhat mechanical in nature. Current binaural head testing devices are incapable of reasonably simulating various aspects of an actual occupant and thus are incapable of providing similar boundary conditions. Current binaural head testing devices are incapable of simulating dynamic aspects including physical response, sound absorption, and physical positioning.

Binaural sensing and testing devices are currently used to perform in-situ acoustical measurements and for other listening reproduction methods. The measurements are performed to simulate acoustical comfort of an occupant. Acoustical measurements are performed only since vibrational measurements are erroneous due to largely disparate characteristics between the testing devices and a vehicle occupant. Three different and distinct loading conditions are observed for acoustical data, static loading, quasi-static loading, and dynamic loading of a seat system.

A binaural testing device including a binaural head and a rigid torso have been used to measure acoustical data and as an attempt to simulate a vehicle occupant. To resemble the vehicle occupant the binaural testing device is positioned in a vehicle seat system such that the binaural head is in an appropriate testing position to simulate actual occupant head positioning. The binaural head may be attached to a stick or rigid member, which may be coupled to a platform that rests on a seat pan cushion. To further simulate a vehicle occupant, ballast weight, which may be in the form of shot bags, is added to the seat system to simulate weight of an occupant. Unfortunately, the above-described binaural testing device does not reasonably simulate a vehicle occupant.

Although, occupant head positioning is reasonable for a fixed position it is unreasonable in that occupant head positioning in actuality is dynamic in that a head of an occupant moves in response to biofidelic characteristics of the occupant. Also, even though there may be an equivalent over all weight in the seating system, the ballast weight does not properly simulate occupant loading on the seating system. The ballast weight, for example, is not distributed about the seat, and is not dynamic in that weight distribution is not changing during a vehicle ride simulation to correspond with biofidelic response of an occupant.

Also, current binaural testing devices do not have lower extremities, which effect seat system loads in a fore, aft, and vertical directions. Again different loading of a seat system can cause different seat system responses and thus, different amounts and types of vibrational and acoustical noise.

Additionally, current binaural testing devices are incapable of replicating various noise artifacts that may be introduced or absorbed by a vehicle occupant.

Conventional seat loads or biofidelic seating apparatuses such as water bottles and anthropomorphic testing devices (ATDs) are not designed for noise vibration and harshness (NVH) performance testing. The conventional seat loads can generate substantial amounts of self-noise, due to fluid moving about or joints squeaking. Often the self-noise is at a high enough level such that an accurate and meaningful binaural sensing measurement is not possible. When binaural sensing data is recorded and replayed to assess sound quality, the recordings contain the self-noise or extraneous noise artifacts. Under these conditions it is difficult to accurately assess sound quality of a testing environment.

Moreover, there is a desire to increase response accuracy of current biofidelic seating apparatuses to be more compliant, so as to have a response that better represents a response of a corresponding human being within a similar seating system. Current biofidelic seating apparatuses are poor representatives of local point mass distributions of a human within a seating system. A human has a corresponding mass distribution on a seating system, which is somewhat irregular and non-uniform in nature and is not accurately represented, both statically and dynamically, by the current biofidelic seating apparatuses.

It is therefore desirable to provide an in-situ binaural testing device that better simulates a vehicle occupant so as to have similar boundary conditions as that of the occupant and is reasonably and accurately capable of measuring acoustical data without artificially generating noise artifacts.

### SUMMARY OF THE INVENTION

The present invention provides a method and system for in-situ acoustical and vibrational measurements including measurements corresponding to occupant head positions within a vehicle. An anthropomorphic testing device is provided including a biofidelic head having substantially correct density, mass, and center of gravity. A biofidelic body is coupled to the biofidelic head and has a skeletal frame structure having substantially correct density, mass, geometry, and compliance. A biofidelic skin covers at least a portion of the skeletal frame structure and has substantially anatomically correct surface geometry, density, and compliance. The biofidelic head may include a binaural sensing system.

The present invention has several advantages over existing binaural testing devices. One advantage is that it provides a binaural testing system that simulates human loading while at the same time providing acoustical signals corresponding to acoustical noise that may be heard by a human.

Another advantage of the present invention is that it provides substantial anatomically correct positioning for measuring accurate acoustical data.

Furthermore, the present invention provides a binaural testing system with substantially correct mass and stiffness distribution characteristics and compliance or dynamic response within a testing environment. Correct mass distribution and dynamic response aids in accurately depicting human or occupant acoustical generation and attenuation.

The present invention itself, together with further objects and attendant advantages, will be best understood by reference to the following detailed description, taken in conjunction with the accompanying drawing.

### BRIEF DESCRIPTION OF THE DRAWINGS

FIG. 1 is a perspective view of an anthropomorphic testing device incorporating a binaural sensing system in accordance with an embodiment of the present invention;

FIG. 2 is a cross-sectional and block diagrammatic view of a biofidelic head and the binaural testing system in accordance with an embodiment of the present invention; and

FIG. 3 is a logic flow diagram illustrating a method of binaurally sensing acoustical frequencies in accordance with an embodiment of the present invention.

### DETAILED DESCRIPTION OF THE PREFERRED EMBODIMENT

In each of the following figures, the same reference numerals are used to refer to the same components. While the present invention is described with respect to a method and apparatus for in-situ acoustical and vibrational measurements including measurements corresponding to occupant head positions within a vehicle, the present invention may be adapted for various applications including vehicle testing systems, acoustical testing systems, vibration testing systems, and other applications known in the art that require the use of a biofidelic seating apparatus or use of a binaural sensing device. The present invention may be utilized within a testing environment including within a vehicle or vehicle simulation apparatus. The present invention may also be used for audio system testing including entertainment systems, communication systems, speech recognition systems, or other systems known in the art. The present invention may be used in subjective sound testing environments and be used in acquiring localization and spatial information.

In the following description, various operating parameters and components are described for one constructed embodiment. These specific parameters and components are included as examples and are not meant to be limiting.

Also, in the following description the term “response” refers to displacement or load history over time. The term “compliance” refers to the inverse of stiffness performance of a seating apparatus during testing thereof. “Natural frequency”, in simple terms, refers to a square root of a corresponding stiffness constant for a device divided by the mass of the device. For example, an object such as a biofidelic seating apparatus, experiences greatest amplitude displacement or response at approximately the natural frequency of the seating apparatus, which is related to stiffness thereof. Also, an object tends to be more resonant at its natural frequency. A device or object may have correct density, amount of mass per unit area, or may have a correct stiffness and not be compliant or have a correct response profile. In order to be compliant an object needs to have proper mass, mass distribution, stiffness, and stiffness distribution so as to provide proper loading to result in a proper response. This concept is described in further detail below.

Additionally, although the following description is directed to human representations and simulations, the present invention may be applied to other animate objects, especially those that have similar structures and organs.

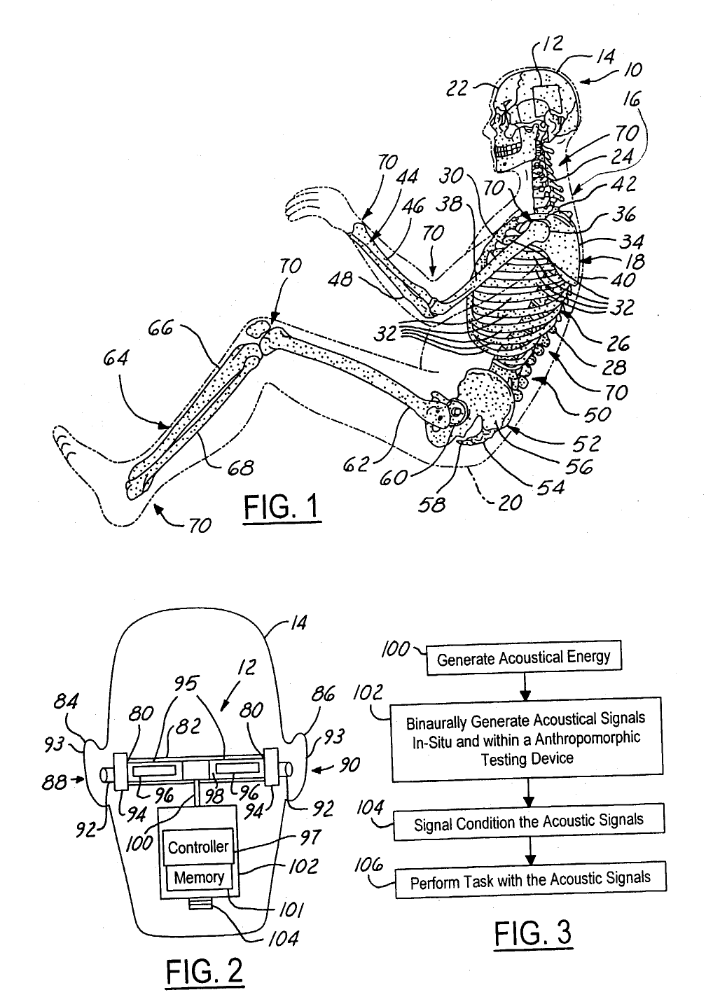

Referring now to FIG. 1, a perspective view of an anthropomorphic testing device (ATD) 10 incorporating a binaural sensing system 12 for in-situ binaural testing in accordance with an embodiment of the present invention is shown. The ATD 10 includes a biofidelic head 14 having the binaural sensing system 12. A biofidelic body 16 is coupled to the head 14. The body 16 has a skeletal frame structure 18 with substantially correct density, mass, geometry, and compliance. A biofidelic skin 20 covers the body 16. The skin 20 has substantially anatomically correct surface geometry, density, and compliance as that of a human. The head 14 and body 16 allow the sensing system 12 to sense surrounding acoustical noise in substantially correct positioning both statically and dynamically. The head 14, the body 16, and the skin 20 may be formed of plastic, metal, or other material known in the art.

The skeletal structure 18 includes a skull 22, a set of cervical vertebrae 24 connected to the skull 22, and a thoracic cage 26 coupled to the cervical vertebrae 24. The thoracic cage 26 includes a set of thoracic vertebrae 28, a sternum 30, and a set of ribs 32 interconnecting the thoracic vertebrae and the sternum 30.

The skeletal structure 18 also includes a pectoral girdle 34 and a pair of ball-and-socket joints 36 (only one shown) for connecting humeri 38 (only one shown) at opposite sides of the thoracic cage 26. The pectoral girdle 34 includes a pair of scapulae 40 (only one shown) connected at opposite sides of the thoracic cage 26 and a pair of clavicles 42 (only one shown) connected to their respective scapulae 40.

A pair of forearms 44 (only one shown) are coupled to their respective humeri 38. Each of the forearms 44 includes a radius 46 (only one shown) and an ulna 48 (only one shown) hingedly connected to its respective humerus 38.

A set of lumbar vertebrae 50 interconnect the thoracic cage 26 to a pelvic girdle 52. The pelvic girdle 52 includes a set of sacrum vertebrae 54 and a pair of ilium 56 (only one shown). A coccyx 58 is connected to the sacrum vertebrae 54. A pair of ball-and-socket joints 60 (only one shown) connect femurs 62 (only one shown) to their respective ilium 56. A pair of legs 64 (only one shown) are connected to the joints 60 having respective femurs 62. In turn each of the legs 64 include a tibia 66 (only one shown) and a fibula 68 (only one shown). Each of the tibiae 66 is hingedly connected to its respective femur 62.

As in a human body the present invention includes multiple joints 70, some are stated above. The joints 70 of the present invention have substantially correct response characteristics including proper mass and stiffness. The joints 70 in conjunction with the above mentioned other structural body members provide proper stiffness distributions throughout the ATD 10. The joints 70 may be of various style, shape, type, and size. The joints 70 may include elbow joints, knee joints, a wrist, a knuckle, an ankle, or other joints known in the art. The joints 70 may be part of a series or set of joints such as vertebrae within a neck or a spine. Any location within the present invention where one part can be moved in relation to an adjacent part may be considered a joint. Mass and stiffness of the joints 70 may be varied by adjusting density, mass, type of material, chemical make-up, size, shape, or other joint parameter known in the art.

The skin 20, which may be in the form of elastomeric plastic, has mechanical properties of bulk muscular tissue in a state of moderate contraction. The mechanical properties include stiffness, inertia, and damping. The skin 20 may have an effective stiffness within a range of approximately 6 kPa to 140 kPa. This stiffness range is not critical for generating a substantially correct response for collection of dynamic vibrational data. The stiffness may vary outside this range as long as mass is also adjusted to compensate for the variance. In doing so, a substantially correct response may be achieved, but static and impact performance of the ATD 10 may be degraded.

Referring now to FIG. 2, a cross-sectional and block diagrammatic view of a biofidelic head 14 and the binaural testing system 12 in accordance with an embodiment of the present invention is shown. Components of the sensing system 12 are configured to operate in relation to each other such that frequency data collected by the system 12 is not only within a range that a human ear is capable of hearing but that it also accurately represents the acoustical characteristics of the human ear. The sensing system 12 may sense surrounding noise or other acoustical signals that may, for example, be generated by surrounding electronic or mechanical devices, such as within a vehicle.

The system 12 is rigidly affixed within the head 14 to prevent generation of acoustical artifacts and to increase durability and operating life of the system 12. The head 14 may be formed or molded such that system 12 tightly fits within the mold or head 14 may be configured such that system 12 may be fastened within the head 14 using brackets, fasteners, or other coupling methods known in the art.

The sensing system 12 includes a pair of microphones 80 each of which are coupled within an extension tube 82. The extension tube 82 is coupled between a left ear 84 and a right ear 86 on a left side 88 and a right side 90 of the head 14, respectively. Acoustical energy enters a pair of ear canals 92 through a pair of external ear segments 93 and causes respective acoustic generators 94 to vibrate and generate acoustic signals, which are signal conditioned within electronic housing 95 via a pair of signal conditioning devices 96. The acoustic generators 94 may be in the form of diaphragms or in some other form known in the art. A controller 97 is coupled to signal conditioning circuitry within the electronic housing 95 via a mounting bracket 98 and cable 100. The controller may store the acoustic signals in a memory 101. The sensing system 12 may provide both analog and digital acoustical signals. Generated acoustical data may be stored or available in real-time.

The controller 97 is mounted within a housing 102 and is coupled to an external connector 104 for external data acquisition. The controller 97 is preferably microprocessor based such as a computer having a central processing unit, memory (RAM and/or ROM), and associated input and output buses. The controller 97 may be a portion of a central main control unit or may be a standalone controller as shown. The controller 97 may be mounted within the head 14, as shown, or be separate from and external to the head 14. The controller 97 may also be part of an internal or external data acquisition system.

The memory 101, as with the controller 97, may be mounted within the housing 102 and may also be internal or external to the head 14. The memory 101 may be located within an internal or external data acquisition system.

Electronics contained within the electronic housings 95 and within the controller 97 are preferable formed of solid-state devices so as to withstand a vibrational testing environment or other more rigorous testing environment known in the art. The electronics may contain filtering having free field or diffuse field equalization.

The ear canals 92 and the external segments 93 as shown are for example purposes only; the ear canals and the external segments 93 may have a more representative geometry as to that of a human ear. The ear canals 92 may have a simple cylindrical shape for ease of ear canal manufacturing and coupling within the head 14 or may be more complex to better simulate an acoustic meatus and middle and internal ear of a human being. The cylindrically shaped ear canals, although simple in design, lack acoustical representation accuracy. When the ear canals 92 are of a simple form, signal conditioning may compensate for the lack of correct acoustical representation by adjusting attenuation characteristics of the generated acoustic signals. Similarly, the external segments 93 may be of a simple form or may be of a more complex design as shown to better represent an auricle of a human. Although the external segments 93 as shown are a close representation of the shape of a human ear, signal conditioning may still be used to finely tune simulation performance of the system 12. Obviously, the more representative are the acoustical characteristics of the ear canals 92 and the external segments 93 the less the system 12 utilizes electronic acoustical signal attenuation.

Referring now to FIG. 3, a logic flow diagram illustrating a method of binaurally sensing acoustical frequencies in accordance with an embodiment of the present invention is shown.

In step 100, acoustical energy is generated within a testing environment having the ATD 10. The acoustical energy may be generated by vibration of a seating system (not shown) and the testing device loading the seating system. For example, the testing device may be in a seated position on a seating system, which is mounted within a vehicle or on a shaker table. As a simulated driving event is created the seating system may vibrate in response to not only simulated driving event signals but also in response to loading of the seating system by the ATD 10. The ATD 10 of the present invention being of substantially correct mass, stiffness, and having substantially correct mass and stiffness distribution in head, body, skin, and joints, provides an accurate and compliant response.

In step 102, the acoustic generators 94 receive the acoustical energy and generate acoustic signals. The acoustic signals are a proportional interpretation of an acoustic environment. When the acoustic generators 94 are in the form of diaphragms they may vibrate to generate the acoustic signals. The acoustic signals are generated in-situ and correspond to positioning of the head 14.

In step 104, the microphones 80 signal condition the acoustic signals. Signal conditioning may include switching, filtering, amplification, attenuation, or other signal conditioning technique known in the art.

In step 106, the controller 97 receives the conditioned acoustic signals and may further condition the signals, store the signals in the memory 101, transfer the signals to an external data acquisition system, or perform some other task known in the art including playback of the acoustic signals for quality assessment.

The above-described steps in the above methods are meant to be an illustrative example, the steps may be performed synchronously, continuously, or in a different order depending upon the application.

The present invention provides an anthropomorphic testing device that has substantially correct mass, mass distribution, and compliance. The present invention also provides a testing device with binaural sensing that has substantially correct geometry and compliance allowing the present invention to generate accurate acoustical representative data that better represents acoustical energy that may be heard by a human ear in a similar environment.

The present invention also provides proper mechanical and acoustical boundary conditions and minimizes generation of any self-noise artifacts, thus further providing a more accurate representation.

The above-described apparatus and method, to one skilled in the art, is capable of being adapted for various applications and systems known in the art. The above-described invention can also be varied without deviating from the true scope of the invention.

What is claimed is:

1. An anthropomorphic testing device comprising:
a biofidelic head having substantially correct density, mass, and center of gravity;
a biofidelic body coupled to said biofidelic head and having a skeletal frame structure having substantially correct density, mass, geometry, and compliance; and
a biofidelic skin covering at least a portion of said skeletal frame structure and having substantially anatomically correct surface geometry, density, and compliance.

2. A device as in claim 1 wherein stiffness of said biofidelic skin is approximately less than 6 kPa or approximately greater than 140 kPa.

3. A device as in claim 1 wherein said biofidelic body includes a plurality of joints having substantially correct compliance.

4. A device as in claim 1 wherein said biofidelic head comprises a binaural sensing system generating acoustic signals.

5. An apparatus as in claim 4 wherein the anthropomorphic testing device comprises at least one acoustical sensing device coupled to said biofidelic head and generating said acoustic signals.

6. An apparatus as in claim 5 wherein said at least one acoustical sensing device is coupled within a tubular section extending between a left side and a right side of said biofidelic head.

7. An apparatus as in claim 5 wherein said at least one acoustical sensing device is coupled within a tubular section extending between a left ear and a right ear of said biofidelic head.

8. An apparatus as in claim 5 wherein said at least one acoustical sensing device is a pair of microphones.

9. An apparatus as in claim 4 biofidelic head comprises:
at least one acoustic generator coupled to said biofidelic head and vibrating in response to an acoustical signal;
at least one acoustical sensing device coupled to said at least one acoustic generator and generating said acoustic signals; and
at least one signal conditioning device coupled to said at least one acoustical sensing device and generating conditioned signals in response to said acoustic signals.

10. An apparatus as in claim 1 wherein said biofidelic head has substantially correct vibrational response.

11. An apparatus as in claim 1 wherein said biofidelic body has substantially correct vibrational response.

12. An apparatus as in claim 1 wherein said skeletal frame structure comprises a thoracic cage having a set of lumbar vertebrae.

13. An apparatus as in claim 1 wherein said skeletal frame structure comprises a pelvic girdle.

14. An apparatus as in claim 1 wherein said biofidelic body comprises at least one extremity.

15. A binaural testing system for an anthropomorphic testing device with a biofidelic body having a skeletal frame structure, said system comprising:
at least one acoustical sensing device coupled within a biofidelic head of the anthropomorphic testing device and generating acoustic signals;
a signal conditioner electrically coupled to said binaural sensing system and generating conditioned signals in response to said acoustic signals; and
a controller initiating generation of said acoustic signal and receiving said conditioned signal.

16. A system as in claim 15 wherein the skeletal frame structure has substantially correct density, mass, geometry, and compliance and a biofidelic skin covering at least a portion of the skeletal frame structure that has substantially anatomically correct surface geometry, density, and compliance.

17. A system as in claim 15 wherein said binaural testing system simulates a human ear canal using a physical configuration.

18. A system as in claim 15 wherein said binaural testing system simulates a human ear canal via electronic attenuation or equalization.

19. A method of binaurally sensing acoustical frequencies comprising:
generating acoustical energy within a testing environment having an anthropomorphic testing device;
generating acoustic signals within a biofidelic sensing system of said anthropomorphic testing device in response to said generated acoustical energy;
signal conditioning said acoustic signals to generate conditioned signals; and
performing a task with said conditioned signals.

20. A method as in claim 19 wherein said acoustic signals are generated in-situ corresponding to positioning of a biofidelic head of said anthropomorphic testing device.
